(19) United States
(12) Patent Application Publication
(10) Pub. No.: US 2026/0301555 A1
(43) Pub. Date: Oct. 1, 2026

(54) WARNING METHOD AND APPARATUS FOR ENVIRONMENT DETECTION, COMPUTER DEVICE, AND STORAGE MEDIUM

(71) Applicant: BOE Technology Group Co., Ltd., Beijing (CN)

(72) Inventor: Pan ZHONG, Beijing (CN)

(21) Appl. No.: 18/992,964

(22) PCT Filed: Jul. 5, 2023
(86) PCT No.: PCT/CN2023/105840

§ 371 Date: Jan. 9, 2025

(30) Foreign Application Priority Data
Jul. 29, 2022 (CN) 202210906240.2

(51) Int. Cl. G08B 21/18; G06V 10/774; G06V 10/82; G06V 20/40; G06V 20/52; G08B 31/00

(52) U.S. Cl. CPC G08B 21/182; G06V 10/774; G06V 10/82; G06V 20/48; G06V 20/52; G08B 31/00

(57) ABSTRACT

Provided is a warning method for environment detection. The method includes: acquiring a video stream of a preset collection region, sequentially collecting frame images from the video stream as detection images, and acquiring an object detection result by inputting the detection images into an image recognition model; determining, in a case that the object detection result comprises a fugitive dust detection box, fugitive dust state information based on positioning information of the fugitive dust detection box; using the fugitive dust state information and the fugitive dust level information as detection data; and giving a fugitive dust warning in a case that a fugitive dust warning condition is satisfied based on the detection data and a historical detection data set; and returning to perform a step of sequentially collecting frame images from the video stream as detection images.

### CROSS-REFERENCE TO RELATED APPLICATIONS

The application a U.S. national phase application based on PCT/CN2023/105840, filed on Jul. 5, 2023, which claims priority to Chinese Patent Application No. 202210906240.2, filed on Jul. 29, 2022 and entitled “WARNING METHOD AND APPARATUS FOR ENVIRONMENT DETECTION, COMPUTER DEVICE, AND STORAGE MEDIUM”, all of which are hereby incorporated by reference in their entireties for all purposes.

### TECHNICAL FIELD

The present disclosure relates to the field of artificial intelligence and object detection technologies, and in particular, relates to a warning method and apparatus for environment detection, a computer device, and a storage medium.

### BACKGROUND

As urban construction and development have been accelerated in recent years, high-rise buildings and rail transit have sprung up and urban construction sites have continued to increase. During construction, a large amount of fugitive dust is generated on the construction sites, which has a great impact on the air environment in cities. In addition, the physical health of persons, who are working in an environment with serious fugitive dust, is negatively affected greatly. Therefore, it is necessary to detect fugitive dust in scenarios such as construction sites.

### SUMMARY

The present disclosure provides a warning method and apparatus for environment detection, a computer device, and a storage medium.

In a first aspect, embodiments of the present disclosure provide a warning method for environment detection. The warning method for environment detection includes:
acquiring a video stream of a preset collection region, sequentially collecting frame images from the video stream as detection images, and acquiring an object detection result by inputting the detection images into an image recognition model, wherein the object detection result includes fugitive dust level information;
in the case that the object detection result includes a fugitive dust detection box, determining fugitive dust state information based on positioning information of the fugitive dust detection box;
using the fugitive dust state information and the fugitive dust level information as detection data; and
giving a fugitive dust warning in the case that a fugitive dust warning condition is satisfied based on the detection data and a historical detection data set; and in the case that the fugitive dust warning condition is satisfied based on the detection data and the historical detection data set, updating the historical detection data set based on the detection data, and returning to perform a step of sequentially collecting frame images from the video stream as detection images.

In some embodiments, the fugitive dust state information includes a first state value representing the presence of fugitive dust and a second state value representing the absence of the fugitive dust; the historical detection data set includes historical detection data corresponding to at least one frame of historical detection image collected historically;
determining the fugitive dust state information based on the positioning information of the fugitive dust detection box includes:
determining whether the fugitive dust detection box satisfies a first preset condition based on the positioning information of the fugitive dust detection box;
determining that the fugitive dust state information is the first state value in the case that the fugitive dust detection box satisfies the first preset condition; and
determining that the fugitive dust state information is the second state value in the case that the fugitive dust detection box does not satisfy the first preset condition; and
determining whether the fugitive dust warning condition is satisfied based on the detection data and the historical detection data set includes:
acquiring a state value sum by accumulatively calculating a sum of state value in the detection data and state values in various historical detection data items in the historical detection data set; and
determining that the fugitive dust warning condition is satisfied in the case that the state value sum is greater than or equal to a first preset threshold.

In some embodiments, the historical detection data set is capable of containing no more than a preset number of historical detection data items; and
updating the historical detection data set based on the detection data includes:
removing, in the case that the number of the historical detection data items in the historical detection data set is equal to the preset number, a historical detection data item with the earliest storage time from a current historical detection data set, and adding the detection data to the historical detection data set as a new historical detection data item.

In some embodiments, the method for environment detection further includes:
using, in the case that the fugitive dust warning condition is not satisfied based on the historical detection data set and the fugitive dust warning condition is satisfied based on the detection data and the historical detection data set, a time on the condition that the detection images are collected as a fugitive dust start time, and generating fugitive dust warning information.

In some embodiments, the detection data includes a fugitive dust level indicated by the fugitive dust level information; and
giving the fugitive dust warning in the case that the fugitive dust warning condition is satisfied based on the detection data and the historical detection data set includes:
giving, in response to a preset warning mechanism being a real-time warning mechanism, the fugitive dust warning based on a fugitive dust level in the detection data and fugitive dust levels in the historical detection data set; and
giving, in response to the preset warning mechanism being an interval warning mechanism and a time difference between a current system time and the last warning time after the fugitive dust warning is given being greater than an interval warning duration, the fugitive dust warning based on the fugitive dust level in the detection data and the fugitive dust levels in the historical detection data set.

In some embodiments, after giving the warning, the method further includes:
determining, in response to a sum of the state values in a preset number of historical detection data items being less than or equal to a second preset threshold, that fugitive dust in the preset collection region ends, and recording a fugitive dust end time.

In some embodiments, the first preset condition includes that an area of the fugitive dust detection box is greater than or equal to a third preset threshold; and/or intersection over union of the fugitive dust detection box and a preset fugitive dust reference box is greater than or equal to a fourth preset threshold.

In some embodiments, after giving the fugitive dust warning, the method further includes:
returning to perform the step of sequentially collecting frame images from the video stream as detection images and acquiring the object detection result by inputting the detection images into the image recognition model, and in the case that the object detection result further includes an exposed soil dreg detection box, determining whether the exposed soil dreg detection box satisfies a second preset condition based on positioning information of the exposed soil dreg detection box; and
giving, in response to each exposed soil dreg detection box satisfying the second preset condition within a first preset frame number range, an exposed soil dreg warning and generating an exposed soil dreg warning information, wherein the exposed soil dreg warning information includes a location of exposed soil dreg within the preset collection region.

In some embodiments, the second preset condition includes that the number of the exposed soil dreg detection boxes is greater than or equal to a fifth preset threshold; and/or an area of the exposed soil dreg detection box is greater than or equal to a sixth preset threshold; and/or intersection over union of the exposed soil dreg detection box and a preset exposed soil dreg reference box is greater than or equal to a seventh preset threshold.

In some embodiments, after giving the fugitive dust warning, the method further includes:
sending, in the case that a fugitive dust level indicated by the fugitive dust warning reaches a preset fugitive dust level, an instruction for persons to evacuate the preset collection region;
returning, in response to receiving an instruction to track the persons, to perform the step of sequentially collecting frame images from the video stream as detection images and acquiring the object detection result by inputting the detection images into the image recognition model, and in the case that the object detection result further includes a person detection box, determining the number of persons in a preset evacuation reference box based on positioning information of the person detection box and positioning information of the preset evacuation reference box; and
giving, in the case that the number of persons is greater than or equal to an eighth preset threshold and an evacuation duration is greater than or equal to a preset evacuation duration, a person evacuation warning, wherein the evacuation duration is a difference between a current system time and an evacuation start time, the evacuation start time being a time responsive to receiving an instruction to track the persons.

In some embodiments, after giving the fugitive dust warning, the method further includes:
returning to perform the step of sequentially collecting frame images from the video stream as detection images, and acquiring the object detection result by inputting the detection images into the image recognition model, and in the case that the object detection result further includes a sign detection box, determining a matching result of the sign detection box and a preset sign reference box based on positioning information of the sign detection box and positioning information of the preset sign reference box;
giving, in the case that the sign detection box does not match the preset sign reference box within a third preset frame number range, a sign warning and generating sign warning information, wherein the sign warning information includes a location of a sign in the preset collection region.

In some embodiments, the step of training the image recognition model includes:
acquiring multi-frame sample images of the preset collection region, and labeling the sample images with sample labels, wherein the sample label includes location information of at least one reference box corresponding to the preset collection region and category information of each reference box, the category information including one of a weather category, a person category, a sign category, and an exposed soil dreg category;
training the image recognition model to be trained based on the sample images and the sample labels; and
constructing a weighted loss value and continuously training the image recognition model by performing weighted backpropagation on the weighted loss value until the weighted loss value converges to acquire a trained image recognition model.

In a second aspect, the embodiments of the present disclosure provide a warning apparatus for environment detection. The warning apparatus for environment detection includes a collection module, an object detection module, a warning analysis module, and a data storage module, wherein
the collection module is configured to acquire a video stream of a preset collection region and sequentially collect frame images from the video stream as detection images;
the object detection module is configured to acquire an object detection result by inputting the detection images into an image recognition model, wherein the object detection result includes fugitive dust level information; in the case that the object detection result includes a fugitive dust detection box, fugitive dust state information is determined based on positioning information of the fugitive dust detection box; and the fugitive dust state information and the fugitive dust level information are used as detection data; and
the warning analysis module is configured to give a fugitive dust warning in the case that a fugitive dust warning condition is satisfied based on the detection data and a historical detection data set; and
the data storage module is configured to update the historical detection data set based on the detection data in the case that the fugitive dust warning condition is satisfied based on the detection data and the historical detection data set.

In a third aspect, the embodiments of the present disclosure further provide a computer device. The computer device includes a processor, a memory, and a bus, wherein the memory stores machine-readable instructions executable by the processor; when the computer device is running, the processor communicates with the memory via the bus; and the processor, when loading and executing the machine-readable instructions, is caused to perform steps of the warning method for environment detection as defined in the first aspect or any embodiments of the first aspect.

In a fourth aspect, the embodiments of the present disclosure further provide a non-transitory computer-readable storage medium storing at least one computer program thereon, wherein the at least one computer program, when loaded and executed by a processor, causes the processor to perform steps of the warning method for environment detection as defined in the first aspect or any embodiments of the first aspect.

### BRIEF DESCRIPTION OF DRAWINGS

FIG. 1 is a flowchart of a warning method for environment detection according to some embodiments of the present disclosure;

FIG. 2A is a part of a specific schematic flowchart of fugitive dust detection according to some embodiments of the present disclosure;

FIG. 2B is another part of a specific schematic flowchart of fugitive dust detection according to some embodiments of the present disclosure;

FIG. 2C is yet another part of a specific schematic flowchart of fugitive dust detection according to some embodiments of the present disclosure;

FIG. 3 is a specific schematic flowchart of exposed soil dreg detection according to some embodiments of the present disclosure;

FIG. 4 is a specific schematic flowchart of safe person evacuation detection according to some embodiments of the present disclosure;

FIG. 5 is a specific schematic flowchart of sign detection according to some embodiments of the present disclosure;

FIG. 6 is a schematic diagram of a network structure of an image recognition model according to some embodiments of the present disclosure;

FIG. 7 is a schematic diagram of a warning apparatus for environment detection according to some embodiments of the present disclosure; and

FIG. 8 is a structural schematic diagram of a computer device according to some embodiments of the present disclosure.

### DETAILED DESCRIPTION

For clearer descriptions of the objectives, technical solutions, and advantages of embodiments of the present disclosure, the technical solutions of the embodiments of the present disclosure are described clearly and completely hereinafter with reference to the accompanying drawings of the embodiments of the present disclosure. Obviously, the embodiments described are only some but not all embodiments of the present disclosure. Usually, components of the embodiments of the present disclosure described and shown in the accompanying figures here may be disposed and designed in a variety of different configurations. Therefore, the following detailed description of the embodiments of the present disclosure provided in the accompanying drawings is not intended to limit the claimed scope of the present disclosure, but rather to represent selected embodiments of the present disclosure. Based on the embodiments of the present disclosure, all other embodiments derived by those skilled in the art without creative efforts shall fall within the protection scope of the present disclosure.

Unless defined otherwise, the technical terms or scientific terms used in the present disclosure should have the normal meaning understood by those of general skill in the art. The terms “first”, “second” and similar terms used in the present disclosure do not denote any order, quantity, or importance, and are merely used to distinguish different components. It should be understood that data used in this way is interchangeable where appropriate, such that the embodiments described here can be implemented in a sequence other than those illustrated or described here. Likewise, the term “one”, “a/an” or “said” and similar terms denote at least one, instead of limitation to quantity. The word “comprise” or “include” and similar terms mean that objects appearing before the term cover the listed objects and its equivalents appearing after the term while other objects are not excluded.

The expression “a plurality of or several” mentioned in the present disclosure refers to two or more. The term “and/or” describes an association relationship of associated objects, indicating that there may be three types of relationships. For example, A and/or B may indicate three situations: A exists alone, A and B exist simultaneously, and B exists alone. The character “/” generally indicates that the associated objects are in an “or” relationship.

Research has found that a traditional detection device for detecting fugitive dust has poor real-time performance in fugitive dust detection and cannot detect a specific situation of the fugitive dust (such as fugitive dust levels). Therefore, it is impossible to make a targeted and relatively reasonable safety management solution for construction sites. It can be seen that traditional fugitive dust detection generally has the problems of feedback delay and high difficulty in supervision, which negatively affects safe construction and engineering efficiency.

Based on the problem that traditional dust detection cannot determine the specific situation of the fugitive dust (such as fugitive dust levels) punctually, embodiments of the present disclosure provide a warning method for environment detection. In this method, a relatively accurate object detection result can be acquired by performing object detection on an image of a preset collection region with a trained and relatively mature image recognition model. The object detection result can directly provide fugitive dust level information. By analyzing historical detection data in a historical detection data set and detection data of currently collected detection images, a fugitive dust warning is given in a targeted manner when a fugitive dust warning condition is satisfied. This can achieve reasonable safety management of an on-site environment corresponding to a video collection region, thereby ensuring safe construction and improving engineering efficiency.

To facilitate understanding of the embodiments, a warning method for environment detection disclosed in the embodiments of the present disclosure is first introduced in detail. An execution subject of the warning method for environment detection provided by the embodiments of the present disclosure is generally a computer device having a certain computing capability. The computer device includes, for example, a terminal device, a server, or other processing device. The terminal device may be a user equipment (UE), a mobile device, a user terminal, a vehicle-mounted device, a wearable device, etc. In some possible embodiments, the warning method for environment detection may be implemented by invoking, by a processor, computer-readable instructions stored in a memory.

The following describes the warning method for environment detection provided by the embodiments of the present disclosure by taking that the execution subject is a server as an example.

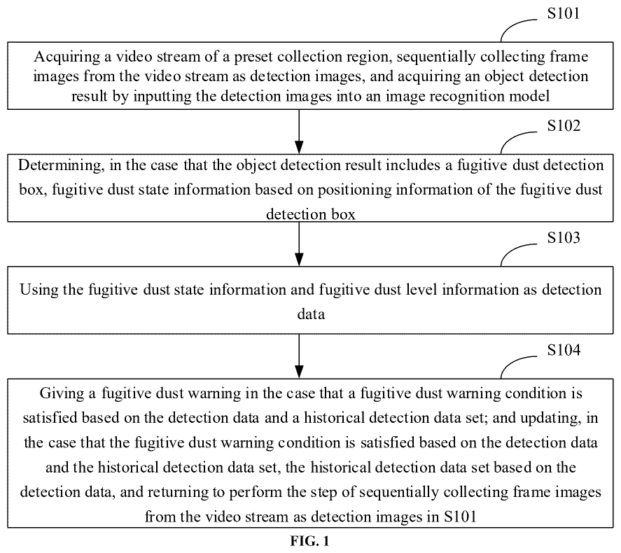

Referring to FIG. 1, which is a flowchart of a warning method for environment detection according to some embodiments of the present disclosure, the method includes steps S101 to S104.

In S101, a video stream of a preset collection region is acquired, frame images are sequentially collected from the video stream as detection images, and an object detection result is acquired by inputting the detection images into an image recognition model.

In this step, the preset collection region may be a fixed region which is preset and associated with fugitive dust detection, such as a region of Interest (ROI). Usually, the preset collection region is set according to a detection task. In the embodiments of the present disclosure, the preset collection region may include regions with a high probability of fugitive dust, such as construction sites.

The video stream in the embodiments of the present disclosure includes, but is not limited to, a video resource transmitted from a real-time streaming protocol. That the frame images are sequentially collected from the video stream may specifically refer to that consecutive frame images are collected from the video stream frame by frame based on a video stream playing order. This consecutive collection method can avoid missing detection of fugitive dust in a certain frame image. Alternatively, it is also possible to collect, based on the video stream playing order, frame images from the video stream by skipping frames at preset interval frame number, and acquire a detection image by skipping frames. This can reduce the number of detection images recognized in an image recognition process while ensuring the fugitive dust recognition accuracy, thereby saving computing resources and reducing the burden of the processor for image recognition. A specific implementation mode may be selected according to actual situations and is not limited in the embodiments of the present disclosure.

Each frame of the collected detection image is detected separately. Specifically, one frame of image collected is used as the detection image and input into the image recognition model to acquire the object detection result. The image recognition model is a pre-trained image recognition model. According to algorithm architecture of the image recognition model, the object detection result output by the image recognition model includes a variety of detection information, such as positioning information of a fugitive dust detection box and fugitive dust level information. It should be noted that in the case that the object detection result does not include the fugitive dust detection box, the positioning information of the fugitive dust detection box is also output, but the positioning information is null information or invalid positioning information which cannot indicate a location in the preset collection region; and in the case that the object detection result does not include the fugitive dust detection box, the fugitive dust level information is also output, but a fugitive dust level is 0, which represents absence of the fugitive dust.

In S102, in the case that the object detection result includes the fugitive dust detection box, fugitive dust state information is determined based on the positioning information of the fugitive dust detection box.

That the object detection result includes the fugitive dust detection box means that the object detection result includes valid positioning information of the fugitive dust detection box. A location indicated by the fugitive dust detection box is a detected location where the fugitive dust exists possibly. The positioning information may indicate a certain location region in a preset detection region.

The fugitive dust state information may be determined based on the positioning information of the fugitive dust detection box. In this step, in the case that the object detection result includes the fugitive dust detection box, it may be determined that the fugitive dust state information indicates the presence of the fugitive dust based on the valid positioning information of the fugitive dust detection box. Alternatively, in the case that the object detection result includes the fugitive dust detection box, whether the fugitive dust detection box satisfies a preset condition (a first preset condition mentioned below) may be further determined, and in the case that the preset condition is satisfied, it is determined that the fugitive dust state information indicates the presence of the fugitive dust.

The fugitive dust state information of the detection image and the fugitive dust level information in the object detection result are recorded, and are stored as a set of data; or are stored after a corresponding relationship between the two is set.

In S103, the fugitive dust state information and the fugitive dust level information are used as detection data.

The fugitive dust state information may be a state value representing a fugitive dust state (which is a number that may be logically operated, i.e., a first state value or a second state value mentioned below), and the fugitive dust level information may be a number representing a fugitive dust level, and the corresponding relationship between the fugitive dust state information and the fugitive dust level information is determined and both the fugitive dust state information and the fugitive dust level information are used as detection data.

In S104, in the case that a fugitive dust warning condition is satisfied based on the detection data and a historical detection data set, a fugitive dust warning is given; and in the case that the fugitive dust warning condition is satisfied based on the detection data and the historical detection data set, the historical detection data set is updated based on the detection data, and the step of sequentially collecting frame images from the video stream as detection images in S101 is performed.

In this step, the historical detection data set includes at least one historical detection data item. The historical detection data is detection data acquired after historically collected detection images are processed by S101 to S103.

During specific implementation, whether the fugitive dust warning condition is satisfied is determined based on the fugitive dust state information indicated by the detection data and the at least one historical detection data item in the historical detection data set; and the fugitive dust warning is given in the case that the fugitive dust warning condition is satisfied.

In some embodiments, in the case that the fugitive dust warning condition is satisfied, the fugitive dust warning may be given based on the fugitive dust level information. Exemplarily, the higher the fugitive dust level indicated by the dust level information is, the more severe the fugitive dust pollution in a current environment is, and thus a higher audible warning frequency may be set; or indicator lights of different colors are correspondingly set to represent different fugitive dust levels, and the corresponding indicator light is turned on based on the corresponding fugitive dust level; or a relevant person is warned in the manner of sending information, wherein the warning information indicates the fugitive dust level.

Updating the historical detection data set based on the detection data specifically means that the detection data may be added to the historical detection data set as the historical detection data directly to determine whether the next detection image satisfies the fugitive dust warning condition. Afterwards, the step of sequentially collecting frame images from the video stream as detection images in S101 is performed to perform fugitive dust detection on the preset collection region continuously.

In the embodiments of the present disclosure, object detection is performed on images of the preset collection region with the trained image recognition model; the fugitive dust level information from fugitive dust detection can be directly acquired according to the algorithm architecture of the image recognition model; and by analyzing the historical detection data in the historical detection data set and the detection data of the currently collected detection images, the fugitive dust warning is given in a targeted manner in the case that the fugitive dust warning condition is satisfied. This can achieve reasonable safety management of the on-site environment corresponding to the video collection region, thereby ensuring safe construction and improving the engineering efficiency.

For S102, the fugitive dust state information includes a first state value representing the presence of the fugitive dust and a second state value representing the absence of the fugitive dust. The fugitive dust state information is determined based on steps S102-1 and S102-2.

In S102-1, whether the fugitive dust detection box satisfies a first preset condition is determined based on the positioning information of the fugitive dust detection box.

The positioning information of the fugitive dust detection box may specifically include positioning coordinates of fugitive dust appearing in the preset collection region, positioning coordinates of the preset collection region are known and the fugitive dust detection box may be a rectangular box. Based on coordinates of certain vertex or center coordinates of the rectangular box as well as the width and height of the rectangular box, an area of the fugitive dust detection box and a specific region of the fugitive dust detection box in the preset collection region may be determined.

The first preset condition includes that the area of the fugitive dust detection box is greater than or equal to a third preset threshold; and/or intersection over union of the fugitive dust detection box and a preset fugitive dust reference box is greater than or equal to a fourth preset threshold. Here, the preset fugitive dust reference box is a preset fixed detection region within the preset collection region, which may be the entire preset collection region or a partial region in the preset collection region. The intersection over union IOU₁ of the fugitive dust detection box and the preset fugitive dust reference box is the ratio of an overlapping region of the fugitive dust detection box and the preset fugitive dust reference box in the preset collection region to the sum of a region covered by the fugitive dust detection box and a region covered by the preset fugitive dust reference box in the preset collection region. It should be noted that the third preset threshold and the fourth preset threshold may be set experientially, which is not specifically limited in the embodiments of the present disclosure.

Exemplarily, in the case that the area of the fugitive dust detection box is greater than or equal to the third preset threshold, it may be determined that the fugitive dust detection box satisfies the first preset condition; and/or based on the specific region of the fugitive dust detection box in the preset collection region and the preset fugitive dust reference box, in the case that the intersection over union IOU₁ of the fugitive dust detection box and the preset fugitive dust reference box is greater than or equal to the fourth preset threshold, it may be determined that the fugitive dust detection box satisfies the first preset condition.

It should be noted that there may be a plurality of fugitive dust detection boxes in the detection image. S102-1 is performed for each fugitive dust detection box; and as long as one of the fugitive dust detection boxes satisfies the first preset condition, it may be determined that the fugitive dust state information of the detection image indicates the presence of the fugitive dust.

In S102-2, it is determined that the fugitive dust state information is the first state value in the case that the fugitive dust detection box satisfies the first preset condition; and it is determined that the fugitive dust state information is the second state value in the case that the fugitive dust detection box does not satisfy the first preset condition.

For example, the first state value may be set to 1; and the second state value may be set to 0.

In the case that the specific state value of the fugitive dust state information is determined by S102-1 and S102-2, whether the fugitive dust warning condition is satisfied is determined based on S103-1 and S103-2.

In S103-1, a state value sum is acquired by accumulatively calculating a sum of the state value in the detection data and state values in various historical detection data items in the historical detection data set.

The state value in the detection data is a state value indicated by the fugitive dust state information (i.e., the first state value or the second state value). The state value in the historical detection data is a state value indicated by fugitive dust state information corresponding to a historical detection image (i.e., the first state value or the second state value).

In some embodiments, to reduce the number of data items stored and improve the operation efficiency of the system, the number of historical detection data items in the historical detection data set may be set to a fixed value in advance, that is, the historical detection data set may only store a certain number of historical detection data items. In the case that the number of historical detection data items in the updated historical detection data set exceeds the set value, the historical detection data first stored in the current historical detection data set may be removed to ensure that the number of data items in the historical detection data set remains unchanged.

By taking that the historical detection data set includes the historical detection data corresponding to N frames of historical detection images as an example, the state values are accumulated. For example, the state values of the N historical detection data items are a₁, a₂ . . . a_{N} respectively, wherein a₁, a₂ . . . a_{N} are 1 or 0, “1” represents the first state value (i.e., the presence of fugitive dust), and “0” represents the second state value (i.e., the absence of fugitive dust); and starting from the first state value, the sum of the state values of the N historical detection data items and the state value of the detection data is determined accumulatively to acquire the state value sum M, i.e., M=a₁+a₂+ . . . +a_{N}+a_{N+1}, wherein a_{N+1} represents the state value of the detection data and is 1 or 0, “1” represents the first state value (i.e., the presence of fugitive dust), and “0” represents the second state value (i.e., the absence of fugitive dust). In the case that it is ensured that accurate fugitive dust detection results may be acquired by detecting a certain number of frames of images, the number of data items stored can be reduced by accumulating a fixed number of frames of state values, and thus the operation efficiency of the system is improved, wherein N is a positive integer greater than 0.

In some embodiments, the amount of historical detection data stored in the historical detection data set may not be limited. Whether the fugitive dust presents may be determined by detecting the certain number of frames of images, and thus to be able to improve the operation efficiency, it is possible to define to accumulate the state value corresponding to a current-frame detection image as well as the state values corresponding to the N frames of historical detection images preceding to the current-frame detection image in the historical detection dataset and in this way, the cumulative sum can also be acquired.

In S103-2, it is determined that the fugitive dust warning condition is satisfied in the case that the state value sum is greater than or equal to a first preset threshold.

The first preset threshold may be set experientially, which is not limited in the embodiments of the present disclosure.

For S104, the historical detection data set is updated based on the detection data and the historical detection data set is capable of containing no more than a preset number of historical detection data items. Specifically, by taking that the historical detection data set has a limited storage capacity as an example, whether the number of historical detection data items in the current historical detection data set reaches the storage upper limit of the historical detection data set, that is, whether the number of historical detection data items in the historical detection data set is equal to the preset number, is determined, and if not, the detection data may be directly added to the historical detection data set as a new historical detection data item. In the case that the number of the historical detection data items in the historical detection data set is equal to the preset number, a historical detection data item with the earliest storage time is removed from the current historical detection data set, and the detection data is added to the historical detection data set as a new historical detection data item. Here, the historical detection data with the earliest storage time is historical detection data with the longest storage time compared with the other historical detection data in the current historical detection data set.

In some embodiments, in the case that the fugitive dust warning condition is not satisfied based on the historical detection data set and the fugitive dust warning condition is satisfied based on the detection data and the historical detection data set, a time on the condition that the detection images are collected is used as a fugitive dust start time and fugitive dust warning information is generated.

Specifically, in the case that the state value sum acquired by accumulating the state values corresponding to the various historical detection data items in the historical detection data set is less than the first preset threshold and the state value sum acquired by accumulating the state value of the detection data and the state values corresponding to the various historical detection data items in the historical detection data set is greater than or equal to the first preset threshold, the time on the condition that the detection images are collected is used as the fugitive dust start time. In the case that the fugitive dust warning information includes a text message sent to the user, the fugitive dust warning information includes the fugitive dust start time.

In some embodiments, the detection data includes a fugitive dust level indicated by the fugitive dust level information. For the fugitive dust warning in S104, different warning mechanisms, such as a real-time warning mechanism and an interval warning mechanism, may be set.

In response to the preset warning mechanism being the real-time warning mechanism, the fugitive dust warning may be given based on the fugitive dust level in the detection data and fugitive dust levels in the historical detection data set. Here, the real-time warning mechanism means that the warning is given as long as the fugitive dust warning condition is satisfied; and in the case that consecutive frames of detection images all satisfy the fugitive dust warning condition, the warning is given continuously without interruption.

In response to the preset warning mechanism being an interval warning mechanism and a time difference between a current system time and the last warning time after the fugitive dust warning is given being greater than an interval warning duration, the fugitive dust warning is given based on the fugitive dust level in the detection data and the fugitive dust levels in the historical detection data set. Here, the interval warning mechanism means that after one fugitive dust warning stops, no warning is given within a preset interval warning duration no matter whether the fugitive dust warning condition is satisfied until the duration after the warning stops exceeds an interval warning duration. Then whether the currently collected detection image satisfies the fugitive dust warning condition is determined and the interval warning mechanism is executed cyclically.

Exemplarily, the fugitive dust warning may be given directly based on the fugitive dust level in the detection data, or based on the fugitive dust level in the detection data and an average level of the various fugitive dust levels in the historical detection data set; or based on the fugitive dust level in the detection data and any one of the various fugitive dust levels in the historical detection data set; or based on the fugitive dust level in the detection data and the average level of part of the various fugitive dust levels in the historical detection data set.

In some embodiments, after the warning is given, it is also possible to detect when the fugitive dust ends. Specifically, in the case that a sum of the state values in a preset number of historical detection data items is less than or equal to a second preset threshold, it is determined that fugitive dust in the preset collection region ends, and a fugitive dust end time is recorded.

Taking that the second state is 0 as an example, the second preset threshold may be set to 0. Alternatively, within an allowable error range, it may be set to 1 or 2 (that is, it is allowed for errors in the object detection results of one to two frames of detection images in N frames of detection images).

Here, after the fugitive dust warning has been given, the step of detecting whether the fugitive dust ends is performed. By continuously updating the historical detection data set, after the fugitive dust in a real scenario ends, the object detection result corresponding to the detection image no longer includes the fugitive dust detection box, that is, cascaded fugitive dust state information at this time is the second state value representing the absence of the fugitive dust. In the case that the sum acquired by accumulating the N state values is equal to 0, it may be determined that the object detection results corresponding to the N frames of detection images all indicate the absence of the fugitive dust, and thus it may be determined that the fugitive dust in the preset collection region ends. In this case, the fugitive dust end time may be a collection time of the historical detection image corresponding to any historical detection data item in the current historical detection data set, or a collection time of the historical detection image corresponding to the first stored historical detection data in the current historical detection data set or a collection time of the historical detection image corresponding to the last stored historical detection data in the current historical detection data set.

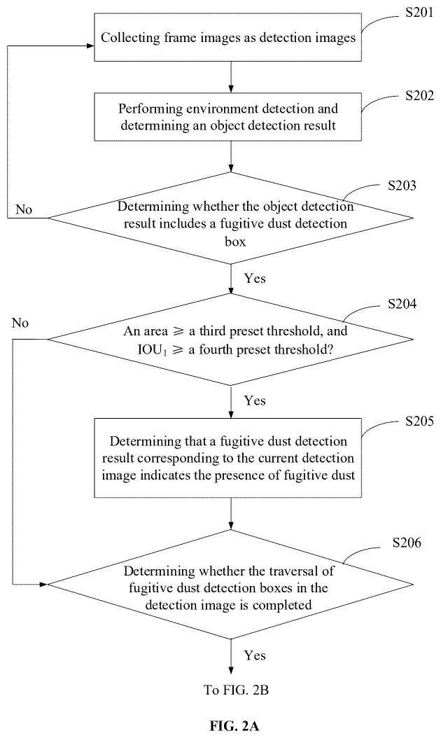

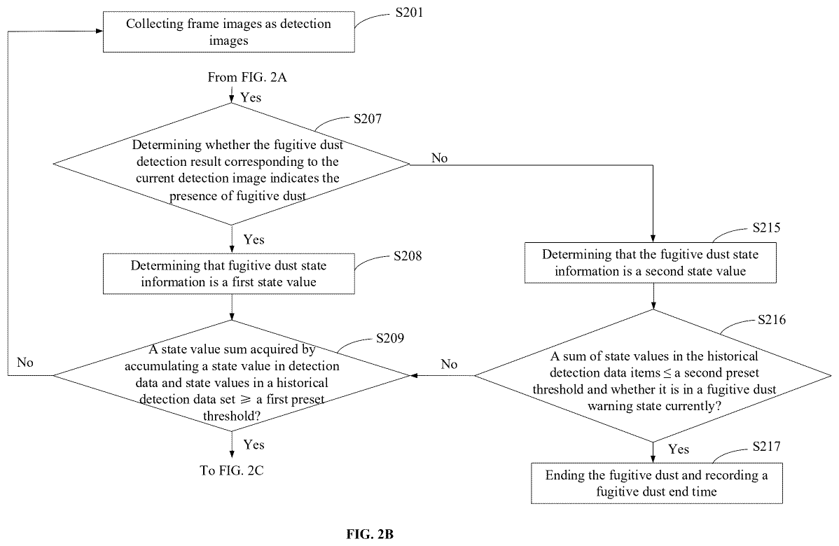

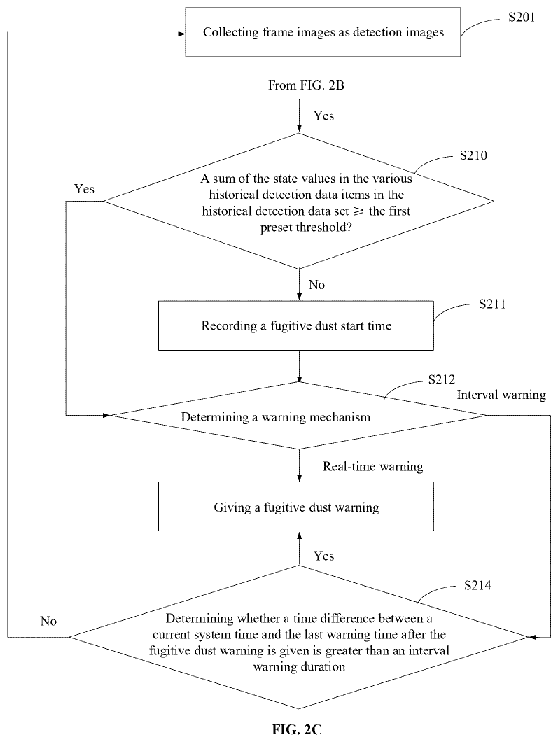

FIG. 2A is a part of a specific schematic flowchart of fugitive dust detection according to some embodiments of the present disclosure, FIG. 2B is another part of a specific schematic flowchart of fugitive dust detection according to some embodiments of the present disclosure, and FIG. 2C is yet another part of a specific schematic flowchart of fugitive dust detection according to some embodiments of the present disclosure. To explain the fugitive dust detection provided by the embodiments of the present disclosure in detail and clearly, based on the above embodiments, a specific execution process of the fugitive dust warning is described below by S201 to S217, as shown in FIG. 2A, FIG. 2B and FIG. 2C.

In S201, frame images are collected as detection images.

In S202, environment detection is performed and an object detection result is determined. Here, the environment detection includes but is not limited to fugitive dust detection.

In S203, whether the object detection result includes a fugitive dust detection box is determined; if so, S204 is performed for one fugitive dust detection box; and if not, S201 is performed.

In S204, whether an area of the fugitive dust detection box is greater than or equal to a third preset threshold is determined and whether intersection over union IOU₁ of the fugitive dust detection box and a preset fugitive dust reference box is greater than or equal to a fourth preset threshold is determined; if both yes, S205 is performed; otherwise, S206 is performed.

In S205, it is determined that the fugitive dust detection result corresponding to the current detection image indicates the presence of fugitive dust.

In S206, whether the traversal of the fugitive dust detection boxes in the detection image is completed is determined; if the traversal is completed, S207 is performed; otherwise, S203 is performed. It should be noted that in the case that the process returns to step S203 when the traversal is not completed, S204 to S206 are performed circularly for each of another fugitive dust detection boxes in the object detection result.

In S207, whether the fugitive dust detection result corresponding to the current detection image indicates the presence of fugitive dust is determined; if yes, S208 is performed; otherwise, S215 is performed.

In S208, it is determined that the fugitive dust state information is the first state value.

In S209, whether an accumulative state value sum acquired by accumulating the state value in the detection data and the state values in various historical detection data items in the historical detection data set is greater than or equal to a first preset threshold is determined; if yes, S210 is performed; otherwise, S201 is performed.

In S210, whether a sum of the state values in the various historical detection data items in the historical detection data set are greater than or equal to the first preset threshold is determined; if yes, S212 is performed; otherwise, S211 is performed.

In S211, a fugitive dust start time is recorded.

In S212, a warning mechanism is determined; if it is a real-time warning mechanism, S213 is performed; and if it is an interval warning mechanism, S214 is performed.

In S213, a fugitive dust warning is given.

In S214, whether difference between a current system time and the last warning time after the fugitive dust warning is given is greater than an interval warning duration is determined; if yes, S213 is performed; otherwise, S201 is performed.

In S215, it is determined that the fugitive dust state information is the second state value.

In S216, whether a sum of the state values in a preset number of historical detection data items is less than or equal to a second preset threshold and whether it is in a fugitive dust warning state currently are determined; if yes, S217 is performed; otherwise, S209 is performed. It should be noted that here whether it is in the fugitive warning state currently is determined; if it has been in the warning state, it may be determined that the fugitive dust has ended in the case that a determination result is yes; and if it is not in the warning state, it indicates that no fugitive dust has occurred and thus there is no need to record the end of fugitive dust, and it only needs to return to execute S209.

In S217, the fugitive dust is ended and a fugitive dust end time is recorded.

In addition to being capable of detecting the fugitive dust, the image recognition model provided by the embodiments of the present disclosure can detect other environment detection tasks related to the environment where the fugitive dust is disposed. For example, the fugitive dust may be accompanied by exposed soil dreg, signs turned over, safe evacuation of persons in the preset collection region and other tasks. The safety of persons in construction may be improved by expanding environment detection. The detection of exposed soil dreg, signs turned over, and safe transfer of persons is performed after it is detected that the fugitive dust presents and the fugitive dust warning is given. The following describes the environment detection of exposed soil dreg, signs turned over, and safe transfer of persons respectively.

In some embodiments, after the fugitive dust warning is given, exposed soil dreg detection is further included. Specifically, the process returns to S101, in the case that the object detection result further includes an exposed soil dreg detection box, whether the exposed soil dreg detection box satisfies a second preset condition is determined based on positioning information of the exposed soil dreg detection box. In the case that each exposed soil dreg detection box satisfies the second preset condition within a first preset frame number range, an exposed soil dreg warning is given and exposed soil dreg warning information is generated, wherein the exposed soil dreg warning information includes a location of exposed soil dreg within the preset collection region.

After the fugitive dust warning is given, a re-collected detection image is input into the image recognition model for object detection, and whether the acquired object detection result includes the exposed soil dreg detection box is determined. A location indicated by the exposed soil dreg detection box is a location where the exposed soil dreg exists.

The second preset condition includes that the number of the exposed soil dreg detection boxes is greater than or equal to a fifth preset threshold; and/or an area of the exposed soil dreg detection box is greater than or equal to a sixth preset threshold; and/or intersection over union of the exposed soil dreg detection box and a preset exposed soil dreg reference box is greater than or equal to a seventh preset threshold. A location indicated by the preset exposed soil dreg reference box is a location of the exposed soil dreg to be detected in a real scenario.

The area of the exposed soil dreg detection box may be calculated based on positioning information of the exposed soil dreg detection box. A setting principle of the preset exposed soil dreg reference box is similar to that of the preset fugitive dust reference box, that is, the preset exposed soil dreg reference box is a fixed detection region within the preset collection region, which may be the entire preset collection region or a partial region in the preset collection region. The intersection over union IOU₂ of the exposed soil dreg detection box and the preset exposed soil dreg reference box, i.e., the ratio of an overlapping region of the exposed soil dreg detection box and the preset exposed soil dreg reference box in the preset collection region to a sum of a region covered by the exposed soil dreg detection box and a region covered by the preset exposed soil dreg reference box in the preset collection region. It should be noted that the fifth preset threshold, the sixth preset threshold, and the seventh preset threshold may be set experientially, which is not specifically limited in the embodiments of the present disclosure.

The first preset frame number range refers to a certain number of frames of continuously collected detection images.

The embodiments of the present disclosure do not limit the form of exposed soil dreg warning. In the case that a user is reminded in the form of a text message, the generated exposed soil dreg warning information may include the location of the exposed soil dreg in the preset collection region.

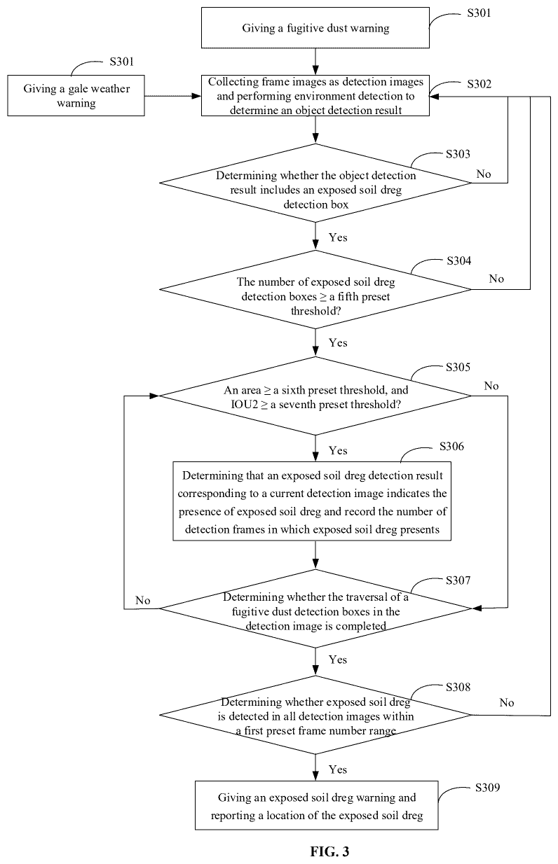

FIG. 3 is a specific schematic flowchart of exposed soil dreg detection according to some embodiments of the present disclosure. To explain exposed soil dreg detection provided by the embodiments of the present disclosure in detail and clearly, based on the above embodiments, a specific execution process of the exposed soil dreg warning is described below by S301 to S309, as shown in FIG. 3.

In S301, a fugitive dust and/or a gale weather warning is given. Here, the gale weather may be a weather situation of a current preset collection region acquired based on network information of weather forecast.

In S302, frame images are collected as detection images, and environment detection is performed to determine an object detection result.

In S303, whether the object detection result includes an exposed soil dreg detection box is determined; if so, S304 is performed; and if not, S302 is performed.

In S304, whether the number of exposed soil dreg detection boxes is greater than or equal to a fifth preset threshold is determined; if yes, S305 is performed; otherwise, S302 is performed.

In S305, for one of the exposed soil dreg detection boxes, whether an area of the exposed soil dreg detection box is greater than or equal to a sixth preset threshold and whether intersection over union IOU₂ of the exposed soil dreg detection box and a preset exposed soil dreg reference box is greater than or equal to a seventh preset threshold are determined; if yes, S306 is performed; otherwise, S307 is performed.

In S306, it is determined that an exposed soil dreg detection result corresponding to the current detection image indicates the presence of exposed soil dreg and the number of detection frames in which exposed soil dreg presents is recorded.

In S307, whether the traversal of the exposed soil dreg detection boxes in the detection image is completed is determined; if the traversal is completed, S308 is performed; otherwise, S305 is performed. It should be noted that in the case that the process returns to step S305 when the traversal is not completed, S305 to S307 are performed circularly for each of another exposed soil dreg detection boxes in the object detection result.

In S308, whether exposed soil dreg is detected in detection images within a first preset frame number range is determined; if so, S309 is performed; otherwise, S302 is performed.

In S309, an exposed soil dreg warning is given, and a location of the exposed soil dreg is reported.

In some embodiments, after the fugitive dust warning is given, the person evacuation detection is further included. Specifically, in the case that the fugitive dust level indicated by the fugitive dust warning reaches a preset fugitive dust level, an instruction for persons to evacuate the preset collection region is sent; in response to receiving an instruction to track the persons, the process returns to S101, in the case that the object detection result also includes a person detection box, the number of persons in a preset evacuation reference box is determined based on positioning information of the person detection box and positioning information of the preset evacuation reference box; and in the case that the number of persons is greater than or equal to an eighth preset threshold and an evacuation duration is greater than a preset evacuation duration, a person evacuation warning is given.

The evacuation duration is a difference between a current system time and an evacuation start time, and the evacuation start time is a time responsive to receiving an instruction to track the persons.

The preset evacuation reference box may be a certain fixed detection region within the preset collection region, which may be the entire preset collection region or a partial region of the preset collection region. A location indicated by the person detection box is locations of persons. The location indicated by the preset evacuation reference box is a location where persons are to be detected to evacuate and generally, it is a location near a sign or a location with a high probability of exposed soil dreg.

Based on the positioning information of the person detection box and the positioning information of the preset evacuation reference box, whether the center point of the person detection box is in the preset evacuation reference box may be determined. There may be a plurality of person detection boxes in the detection image. For each person detection box, in the case that the center point of the person detection box is in the preset evacuation reference box, it is determined that there is a person in the preset evacuation reference box. Based on this, traversal of each person detection box is performed to determine the number of persons in the preset evacuation reference box. In the case that the number of persons reaches a preset upper limit (the eighth preset threshold), whether the evacuation duration has passed, that is, whether the evacuation duration is greater than the preset evacuation duration, is further determined; and if so, urge prompt information of person evacuation warning is sent to persons.

In addition, while the number of persons is determined, in the case that the number of persons is zero within a second preset frame number range, evacuation end information is generated. That is, in the case that no person detection box is detected in the detection images collected within a period of time, it may be determined that the persons have been evacuated.

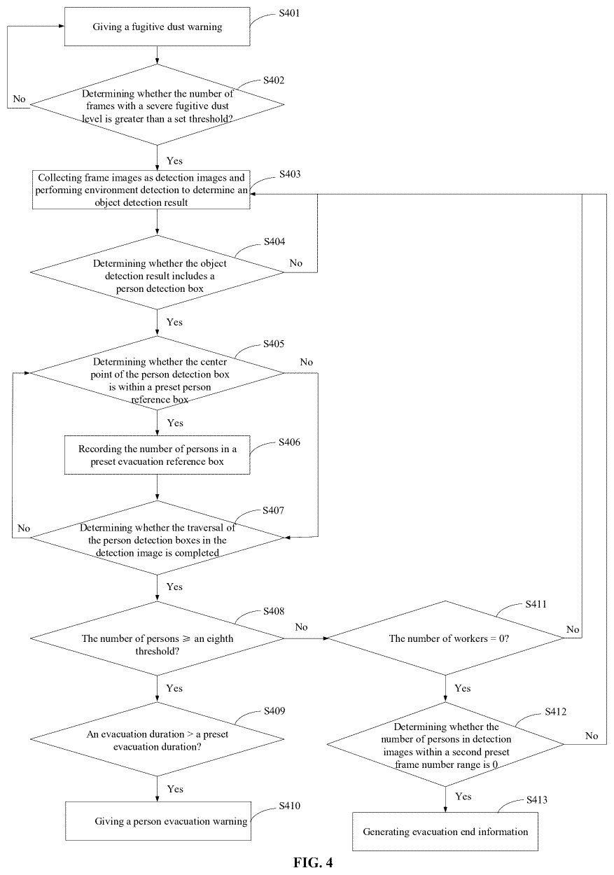

FIG. 4 is a specific schematic flowchart of safe person evacuation detection according to some embodiments of the present disclosure. To explain the safe person evacuation detection provided by the embodiments of the present disclosure in detail and clearly, based on the above embodiments, a specific execution process of the person evacuation warning is described below by S401 to S413, as shown in FIG. 4.

In S401, a fugitive dust warning is given.

In S402, based on fugitive dust levels in various historical detection data items in a historical detection data set and a fugitive dust level in detection data, whether the number of frames with a severe fugitive dust level is greater than a set threshold is determined; if so, S403 is performed; otherwise, S401 is performed.

In S403, frame images are collected as detection images and environment detection is performed to determine an object detection result.

In S404, whether the object detection result includes a person detection box is determined; if so, S405 is performed; otherwise, S403 is performed.

In S405, for one of the person detection boxes in the detection image, whether the center point of the person detection box is within a preset person reference box is determined; if so, S406 is performed; otherwise, S407 is performed.

In S406, the number of persons in a preset evacuation reference box is recorded.

In S407, whether the traversal of the person detection boxes in the detection image is completed is determined; if the traversal is completed, S408 is performed; otherwise, S405 is performed. It should be noted that in the case that the process returns to step S405 when the traversal is not completed, S405 to S407 are performed circularly for each of another person detection boxes in the object detection result.

In S408, whether the number of persons is greater than or equal to an eighth preset threshold is determined; if yes, S409 is performed; otherwise, S411 is performed.

In S409, whether an evacuation duration is greater than a preset evacuation duration is determined; if so, S410 is performed; otherwise, S403 is performed.

In S410, a person evacuation warning is given.

In S411, whether the number of persons is equal to 0 is determined; if so, S412 is performed; otherwise, S403 is performed.

In S412, whether the number of persons in detection images within a second preset frame number range is 0 is determined; if so, S413 is performed; otherwise, S403 is performed.

In S413, evacuation end information is generated.

In some embodiments, after the fugitive dust warning is given, the person evacuation detection is further included. Specifically, the process returns to S101, in the case that the object detection result further includes a sign detection box, a matching result of the sign detection box and a preset sign reference box is determined based on positioning information of the sign detection box and positioning information of the preset sign reference box; and in the case that the sign detection box does not match the preset sign reference box within a third preset frame number range, a sign warning is given and sign warning information is generated, wherein the sign warning information includes a location of a sign in the preset collection region.

After the fugitive dust warning is given, a re-collected detection image is input into the image recognition model for object detection, and whether the acquired object detection result includes the sign detection box is determined. A location indicated by the sign detection box is a location of a sign in the detection image. A location indicated by the preset sign reference box is a location of the sign specified in a real scenario.

Whether the sign detection box matches the preset sign reference box is determined. Specifically, whether intersection over union of the sign detection box and the preset sign reference box is greater than or equal to a preset threshold is determined, and the preset threshold here may be set experientially. For example, in one case, the preset threshold may be set to 1, that is, the intersection over union is 1, and then it is determined that the sign detection box completely matches the preset sign reference box. Alternatively, in the case that a detection error is allowable, the preset threshold may be set to 0.95; and if the intersection over union is greater than 0.95, it is determined that the sign detection box matches the preset sign reference box; otherwise, it is determined that the sign detection box does not match the preset sign reference box.

In the case that in the object detection results of multi-frame continuously collected detection images (that is, detection images within the third preset frame number range), the corresponding sign detection box does not match the preset sign reference box, and a sign warning is given. It should be noted that in the case that the matching result of the sign detection box and the preset sign reference box indicates that the sign detection box does not match the preset sign reference box, it may be considered that a sign is turned over (or shifted from a preset position) caused by fugitive dust (or other factors); and there is no directional information during construction in this region as the sign is turned over, which increases the risk of construction persons. Therefore, when it is detected that the sign detection box does not match the preset sign reference box, safety maintenance persons are organized punctually to handle the sign turned over to ensure the safety of persons in the region corresponding to the sign turned over.

The embodiments of the present disclosure do not limit the form of sign warning. In the case that there is a sign in the detection image, when a user is reminded in the form of a text message, the generated sign warning information may include a location of at least one unmatched sign in the preset collection region.

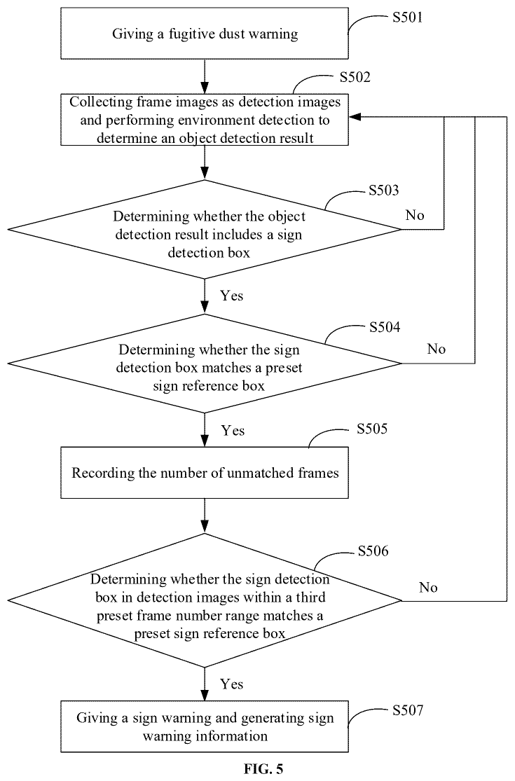

FIG. 5 is a specific schematic flowchart of sign detection according to some embodiments of the present disclosure. To explain sign detection provided by the embodiments of the present disclosure in detail and clearly, based on the above embodiments, a specific execution process of the sign warning is described below by S501 to S507, as shown in FIG. 5.

In S501, a fugitive dust warning is given.

In S502, frame images are collected as detection images, and an object detection result is determined by performing environment detection.

In S503, whether the object detection result includes a sign detection box is determined; if so, S504 is performed; and if not, S502 is performed.

In S504, whether the sign detection box matches a preset sign reference box is determined based on positioning information of the sign detection box and positioning information of the preset sign reference box; if not, S505 is performed; otherwise, S502 is performed.

In S505, the number of unmatched frames is recorded.

In S506, whether the sign detection box in the detection image within a third preset frame number range matches the preset sign reference box is determined; if so, S507 is performed; otherwise, S502 is performed.

In S507, a sign warning is given and sign warning information is generated.

Embodiments of the present disclosure further provide a method for training an image recognition model. Specifically, an execution subject of the method may be a server for executing the warning method for environment detection in the above embodiments, or a separate server. In the embodiments of the present disclosure, the illustration is given by taking that the execution subject of the method is the server for executing the warning method for environment detection in the above embodiments as an example, and specific training steps are S601 to S603.

In S601, multi-frame sample images of the preset collection region are acquired, and the sample images are labeled with sample labels.

The sample images may be image information at different time nodes, mainly including video images under different weather and lighting conditions. It should be noted that the sample images may be images collected online, in a preset collection region, or images stored in advance, in the preset collection region.

The sample label includes location information of at least one reference box corresponding to the preset collection region and category information of each reference box; the category information includes one of a weather category, a person category, a sign category, and an exposed soil dreg category; and the weather category may include rain, snow, fog, fugitive dust, sunny, etc.

In the embodiments of the present disclosure, the image recognition model is trained by setting sample labels of different weather categories, which can avoid false detection of fugitive dust due to rainy, snowy, and foggy weather. That is, in the embodiments of the present disclosure, more accurate fugitive dust detection results can be acquired by the trained image recognition model and thus the environment detection accuracy is improved.

In S602, the image recognition model to be trained is trained based on the sample images and the sample labels.

The image recognition model to be trained may be an image recognition technology yolov5-based deep neural network for object detection. FIG. 6 is a schematic diagram of a network structure of an image recognition model according to some embodiments of the present disclosure. As shown in FIG. 6, a base detector is a master network of yolov5, cls represents a category branch, reg represents a regression branch of prediction box coordinates, obj represents a foreground confidence branch, and level represents a fugitive dust level prediction branch. The base detector is a feature extraction process, which is specifically implemented by multi-layer convolution. Pre-processed sample images are input and a feature map list with the length of 5, i.e., [f₁, f₂, f₃, f₄, f₅] is output. For the category branch cls, the regression branch reg of the prediction box coordinates, and the foreground confidence branch obj, there are three original heads, which are applied to f₃, f₄, and fₛ respectively. Specifically, it is implemented by a layer of 1×1 convolution. The number of convolution input channels=the number of output feature map channels, and the number of output channels=na*no, wherein na is the number of set original anchors, which is 3; and no=7+5, wherein 7 is the number of object categories, indicating seven categories, i.e., rain, snow, fog, fugitive dust, persons, signs, and exposed soil dreg, and 5 is five components of the prediction box coordinate regression, i.e., [x, y, w, h, p], wherein x represents the horizontal coordinate of the center point of the prediction box, y represents the vertical coordinate of the center point of the prediction box, w represents the width of the center point of the prediction box, h represents the height of the center point of the prediction box, and p represents the probability of the category to which the prediction box belongs (that is, foreground confidence). The fugitive dust level branch level is composed of a layer of 1×1 convolution, and the number of output channels is 4, i.e., [c₁, c₂, c₃, c₄], wherein c₁, c₂, c₃, and c₄ indicate the probabilities that the fugitive dust level is no fugitive dust, weak fugitive dust, medium fugitive dust, and severe fugitive dust, respectively.

In the embodiments of the present disclosure, based on the object category and prediction box coordinate regression, the fugitive dust level of the fugitive dust corresponding to the prediction box can be acquired by introducing the fugitive dust level branch at the feature map fₛ with the smallest scale.

N prediction boxes σ are acquired by training with the image recognition model shown in FIG. 6 based on the sample images and sample labels. An i^{th} prediction box a includes seven components of the object category, i.e., [b₁, b₂, b₃, b₄, b₅, b₆, b₇], five components of the prediction box coordinate regression, i.e., [xᵢ, yᵢ, wᵢ, hᵢ, pᵢ], and four components of fugitive dust levels, i.e., [c₁, c₂, c₃, c₄], wherein b₁, b₂, b₃, b₄, b₅, b₆, b₇ are category probabilities of rain, snow, fog, fugitive dust, persons, signs, and exposed soil dreg, respectively; xᵢ, yᵢ, wᵢ, hᵢ represent the horizontal coordinate and vertical coordinate of the center point of the i^{th} prediction box as well as the width and height of the i^{th} prediction box, respectively; and pᵢ represents the probability that the prediction category is a category of the i^{th} prediction box (that is, the foreground confidence of the i^{th} detection box); and c₁ represents the fugitive dust level.

Specifically, the category of the i^{th} prediction box may be determined based on the size of the values of the probabilities b₁, b₂, b₃, b₄, b₅, b₆, b₇. For example, assuming that b₄ is the largest among b₁, b₂, b₃, b₄, b₅, b₆, b₇, it is determined the i^{th} prediction box is a fugitive dust prediction box; similarly, assuming that b₅ is the largest, then it is determined that the i^{th} prediction box is a person prediction box; assuming that b₆ is the largest, it is determined that the i^{th} prediction box is a sign prediction box; and assuming that b₇ is the largest, it is determined that the i^{th} prediction box is an exposed soil dreg prediction box. 0<i≤n, wherein n is an integer greater than or equal to 1.

In S603, a weighted loss value is constructed and the image recognition model is continuously trained by performing weighted backpropagation on the weighted loss value until the weighted loss value converges to acquire a trained image recognition model.

By using the method for training the image recognition model provided by the embodiments of the present disclosure, based on the model composed of yolov5 and fugitive dust level branch architecture, the weighted loss value is constructed and subjected to reverse weighted propagation, which solves the problem that some object regions cannot be detected or detected incorrectly and improves the accuracy of the model. In addition, by using the image recognition model, the detection result of the fugitive dust level can be directly acquired, thereby realizing the prediction of the fugitive dust levels.

For the training of the image recognition model in S603, please refer to S603-1 to S603-3 for details.

In S603-1, a plurality of prediction boxes output by the image recognition model, category information of each prediction box, foreground confidence of each prediction box, and the predicted fugitive dust level of the fugitive dust category indicated by the category information are acquired.

In S603-2, a first loss value corresponding to each prediction box is acquired by iteratively calculating the intersection over union of each prediction box and the corresponding reference box; a second loss value between the category information of each prediction box and a preset category label is iteratively calculated; a third loss value between the foreground confidence of each prediction box and reference foreground confidence is iteratively calculated; and a fourth loss value between the predicted fugitive dust level of the fugitive dust prediction box corresponding to the fugitive dust category and a reference fugitive dust level is iteratively calculated.

Here, the reference boxes are pre-set reference boxes corresponding to the various categories respectively, i.e., reference boxes corresponding to the seven categories of rain, snow, fog, fugitive dust, persons, signs, and exposed soil dreg, respectively.

The intersection over union of each prediction box and the corresponding reference box is iteratively calculated. By taking the i^{th} prediction box as an example, an overlapping area S₁ of the i^{th} prediction box and its corresponding reference box is calculated. Then, based on the overlapping area S₁, the intersection over union IOU₂ of the i^{th} prediction box and its corresponding reference box is calculated, that is, IOU₂=S₁/(S₂+S₃−S₁), wherein S2 represents the area of the i^{th} prediction box, and S₃ indicates the area of the corresponding reference box. Subsequently, the IOU₂ may be used as the first loss value L_{reg} of the i^{th} prediction box.

The second loss value L_{cle} between the category information of each prediction box and the preset category label is iteratively calculated, which may refer to formula 1:

$${L}_{c l e} = - [ t log {t}^{′} + ( 1 - t ) ] log ( 1 - {t}^{′} ) , \qquad formula 1$$

wherein t may represent the preset category label, that is, real category information of the prediction box; t′ may represent the category information predicted by the prediction box, that is, a value output by the model/a predicted value.

The third loss value L_{obj} between the foreground confidence of each prediction box and reference foreground confidence is iteratively calculated, which may refer to formula 1. It should be noted that when the third loss value is calculated by the formula 1, t may represent the reference foreground confidence, that is, real foreground confidence of the prediction box; and t′ may represent the foreground confidence predicted by the prediction box, that is, a value output by the model/a predicted value.

The fourth loss value Lₗₑᵥₑₗ between the predicted fugitive dust level of the fugitive dust prediction box corresponding to the fugitive dust category and the reference fugitive dust level is iteratively calculated, which may refer to formula 1. It should be noted that when the fourth loss value is calculated by the formula 1, t may represent a reference fugitive dust level, that is, a real fugitive dust level of the prediction box; t′ may represent the fugitive dust level predicted by the prediction box, that is, a value output by the model/a predicted value.

Due to blurred boundaries at the boundaries of different fugitive dust levels, the label smooth method is used for fugitive dust level labels in the training process to avoid the image recognition model from being overconfident in the correct label and reduce a difference between positive and negative sample prediction values. Refer to formula 2 for label smooth:

$$t = {t}_{onehot} \times ( 1 - α ) + \frac{α}{K} . \qquad formula 2$$

In this formula, tₒₙₑₕₒₜ represents a label code of the fugitive dust level (i.e., the label codes of no fugitive dust, weak fugitive dust, medium fugitive dust, and severe fugitive dust); α is a hyperparameter, K is the number of fugitive dust levels, and the number of fugitive dust levels K is 4 in the embodiments of the present disclosure, that is, there are four levels, i.e., no fugitive dust, weak fugitive dust, medium fugitive dust, and severe fugitive dust.

In S603-3, the sum of the first loss value, the second loss value, the third loss value, and the fourth loss value is used as a total loss value Lₜₒₜₐₗ, and backpropagation is performed based on the total loss value Lₜₒₜₐₗ to continuously train the image recognition model.

$$The total loss value {L}_{total} = {L}_{obj} + {L}_{cls} + {L}_{r e g} + {L}_{l e v e l} .$$

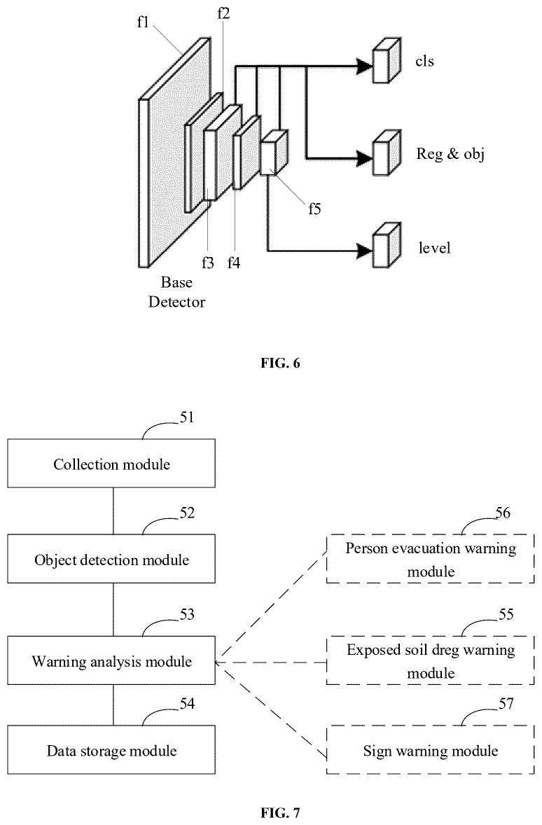

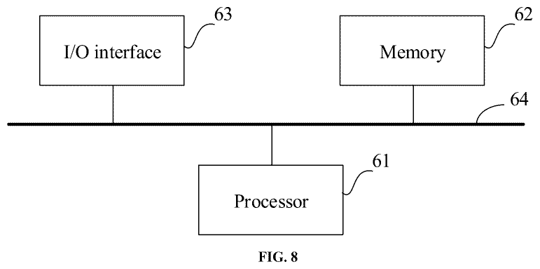

In a second aspect, based on the same inventive concept, the embodiments of the present disclosure further provide a warning apparatus for environment detection. FIG. 7 is a schematic diagram of a warning apparatus for environment detection according to some embodiments of the present disclosure. As shown in FIG. 7, the warning apparatus for environment detection includes a collection module 51, an object detection module 52, a warning analysis module 53, and a data storage module 54.

The collection module 51 is configured to acquire a video stream of a preset collection region and sequentially collect frame images from the video stream as detection images.

The object detection module 52 is configured to acquire an object detection result by inputting the detection images into an image recognition model, wherein the object detection result includes fugitive dust level information; in the case that the object detection result includes a fugitive dust detection box, fugitive dust state information is determined based on positioning information of the fugitive dust detection box; the fugitive dust state information of the detection images and the fugitive dust level information in the object detection result is recorded; and the fugitive dust state information and the fugitive dust level information area used as detection data.

The warning analysis module 53 is configured to give a fugitive dust warning in the case that a fugitive dust warning condition is satisfied based on the detection data and a historical detection data set.

The data storage module 54 is configured to update the historical detection data set based on the detection data in the case that the fugitive dust warning condition is satisfied based on the detection data and the historical detection data set.

In some embodiments, the fugitive dust state information includes a first state value representing the presence of fugitive dust and a second state value representing the absence of fugitive dust; and the historical detection data set includes historical detection data corresponding to at least one frame of historical detection image collected historically.

When determining the fugitive dust state, the object detection module 52 is specifically configured to determine whether the fugitive dust detection box satisfies a first preset condition based on the positioning information of the fugitive dust detection box; determine that the fugitive dust state information is the first state value in the case that the fugitive dust detection box satisfies the first preset condition; and determine that the fugitive dust state information is the second state value in the case that the fugitive dust detection box does not satisfy the first preset condition. The warning analysis module 53 includes a warning condition determination unit. The warning condition determination unit is configured to acquire a state value sum by accumulatively calculating a sum of the state value in the detection data and states values in various historical detection data items in the historical detection data set; and determine that the fugitive dust warning condition is satisfied in the case that the state value sum is greater than or equal to a first preset threshold.

In some embodiments, the historical detection data set is capable of containing no more than a preset number of historical detection data items; and the data storage module 54 is configured to remove, in the case that the number of the historical detection data items in the historical detection data set is equal to the preset number, a historical detection data item with the earliest storage time from a current historical detection data set, and add the detection data to the historical detection data set as a new historical detection data item.

In some embodiments, the warning analysis module 53 is further configured to use, in the case that the fugitive dust warning condition is not satisfied based on the historical detection data set and the fugitive dust warning condition is satisfied based on the detection data and the historical detection data set, a time on the condition that the detection images are collected as a fugitive dust start time, and generate fugitive dust warning information.

In some embodiments, the detection data includes a fugitive dust level indicated by the fugitive dust level information.

The warning analysis module 53 is configured to give, in response to a preset warning mechanism being a real-time warning mechanism, the fugitive dust warning based on a fugitive dust level in the detection data and fugitive dust levels in the historical detection data set; and give, in response to the preset warning mechanism being an interval warning mechanism and a time difference between a current system time and the last warning time after the fugitive dust warning is given being greater than an interval warning duration, the fugitive dust warning based on the fugitive dust level in the detection data and the fugitive dust levels in the historical detection data set.

In some embodiments, the warning analysis module 53 is further configured to determine after the warning is given, in response to a sum of the state values in a preset number of historical detection data items being less than or equal to a second preset threshold, that fugitive dust in the preset collection region ends, and record a fugitive dust end time.

In some embodiments, the first preset condition includes that an area of the fugitive dust detection box is greater than or equal to a third preset threshold; and/or intersection over union of the fugitive dust detection box and a preset fugitive dust reference box is greater than or equal to a fourth preset threshold.

In some embodiments, the warning apparatus for environment detection further includes an exposed soil dreg warning module 55. The exposed soil dreg warning module 55 is configured to determine, after the fugitive dust warning is given, in the case that the object detection result further includes an exposed soil dreg detection box, whether the exposed soil dreg detection box satisfies a second preset condition based on positioning information of the exposed soil dreg detection box; and give, in response to each exposed soil dreg detection box satisfying the second preset condition within a first preset frame number range, an exposed soil dreg warning and generate exposed soil dreg warning information, wherein the exposed soil dreg warning information includes a location of exposed soil dregs within the preset collection region.

In some embodiments, the second preset condition includes that the number of the exposed soil dreg detection boxes is greater than or equal to a fifth preset threshold; and/or an area of the exposed soil dreg detection box is greater than or equal to a sixth preset threshold; and/or intersection over union of the exposed soil dreg detection box and a preset exposed soil dreg reference box is greater than or equal to a seventh preset threshold.

In some embodiments, the warning apparatus for environment detection further includes a person evacuation warning module 56. The person evacuation warning module 56 is configured to send, after the fugitive dust warning is given, in the case that a fugitive dust level indicated by the fugitive dust warning reaches a preset fugitive dust level, an instruction for persons to evacuate the preset collection region; return, in response to receiving an instruction to track the persons, to perform the step of sequentially collecting frame images from the video stream as detection images and acquiring the object detection result by inputting the detection images into the image recognition model, and determine, in the case that the object detection result further includes a person detection box, the number of persons in a preset evacuation reference box based on positioning information of the person detection box and positioning information of the preset evacuation reference box; and give, in the case that the number of persons is greater than or equal to an eighth preset threshold and an evacuation duration is greater than or equal to a preset evacuation duration, a person evacuation warning, wherein the evacuation duration is a difference between a current system time and an evacuation start time, the evacuation start time being a time responsive to receiving an instruction to track the persons.

In some embodiments, the warning apparatus for environment detection further includes a sign warning module 57. The sign warning module 57 is configured to determine, after the fugitive dust warning is given, in the case that the object detection result further includes a sign detection box, a matching result of the sign detection box and a preset sign reference box based on positioning information of the sign detection box and positioning information of the preset sign reference box; and give, in the case that the sign detection box does not match the preset sign reference box within a third preset frame number range, a sign warning and generate sign warning information, wherein the sign warning information includes a location of a sign in the preset collection region.

In some embodiments, the warning apparatus for environment detection further includes a model training module 58. The model training module 58 is configured to train the image recognition model. The model training module 58 is specifically configured to acquire multi-frame sample images of the preset collection region, and label the sample images with sample labels, wherein the sample labels include location information of at least one reference box corresponding to the preset collection region and category information of each reference box, the category information including one of a weather category, a person category, a sign category, and an exposed soil dreg category; train the image recognition model to be trained based on the sample images and the sample labels; and construct a weighted loss value and continuously train the image recognition model by performing weighted backpropagation on the weighted loss value until the weighted loss value converges to acquire a trained image recognition model.

In a third aspect, FIG. 8 is a structural schematic diagram of a computer device according to some embodiments of the present disclosure. As shown in FIG. 8, the embodiments of the present disclosure provide a computer device. The computer device includes one or more processors 61, a memory 62, and one or more I/O interfaces 63. One or more programs are stored on the memory 62. The one or more programs, when executed by the one or more processors, cause the one or more processors to perform the warning method for environment detection according to any one of the above embodiments. The one or more I/O interfaces 63 are connected between the processor and the memory, and are configured to implement information interaction between the processor and the memory.

The processor 61 is a device having data processing capabilities, including but not limited to a central processing unit (CPU). The memory 62 is a device having data storage capabilities, including but not limited to a random access memory (RAM, more specifically such as an SDRAM or a DDR), a read-only memory (ROM), an electrically erasable programmable read-only memory (EEPROM) and a flash memory. The I/O interface (read-write interface) 63 is connected between the processor 61 and the memory 62, may realize information interaction between the processor 61 and the memory 62, and includes but is not limited to a data bus.

In some embodiments, the processor 61, the memory 62, and the I/O interface 63 are connected to each other via the bus 64 and thus connected to other components of a computing device.

According to the embodiments of the present disclosure, a non-transitory computer-readable medium is also provided. The non-transitory computer-readable medium stores at least one computer program thereon, wherein the at least one program, when loaded and executed by a processor, causes the processor to perform the steps in the warning method for environment detection according to any one of the above embodiments.

In particular, according to the embodiments of the present disclosure, the processes described with reference to the flowcharts above may be implemented as computer software programs. For example, the embodiments of the present disclosure include a computer program product. The computer program product includes a computer program carried on a machine-readable medium. The computer program contains program codes for performing the method illustrated in the flowchart. In such embodiments, the computer program may be downloaded and installed from the network via a communication component, and/or installed from a removable medium. The computer program, when executed by a central processing unit (CPU), executes the above functions defined in the system of the present disclosure.

It should be noted that the non-transitory computer-readable medium shown in the present disclosure may be a computer-readable signal medium, a computer-readable storage medium, or any combination thereof. The computer-readable storage medium may be, but is not limited to, for example, an electrical, magnetic, optical, electromagnetic, infrared, or semiconductor system, apparatus, or device, or any combination thereof. More specific examples of the computer-readable storage medium may include but are not limited to an electrical connection having one or more conducting wires, a portable computer disk, a hard disk, a random-access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium may be any tangible medium that includes or stores a program, and the program may be used by or in combination with an instruction execution system, apparatus, or device. In the present disclosure, the computer-readable signal medium may include a data signal propagated in a baseband or as a part of a carrier, which carries computer-readable program codes. Such a propagated data signal may be in multiple forms, including but not limited to an electromagnetic signal, an optical signal, or any suitable combination thereof. The computer-readable signal medium may further be any non-transitory computer-readable medium other than the computer-readable storage medium, and the non-transitory computer-readable medium may send, propagate, or transmit a program that is used by or in combination with an instruction execution system, apparatus, or device. The program code included in the non-transitory computer-readable medium may be transmitted by using any suitable medium, including but not limited to: a wireless medium, a wire, an optical cable, an RF, or any suitable combination thereof.

Flowcharts and block diagrams in the accompanying drawings illustrate possible implementation architectures, functions, and operations of apparatus, methods, and computer program products according to various embodiments of the present disclosure. In this regard, each block in a flowchart or block diagram may represent a module, a program segment, or part of code that includes one or more executable instructions for implementing a specified logical function. It should also be noted that in some alternative implementations, functions indicated in the blocks may also be implemented in different order than those indicated in the accompanying drawings. For example, two blocks represented in succession may actually be executed in substantially parallel, and they may sometimes be executed in a reverse order, depending on the functions involved. It should also be noted that each block in the block diagram and/or flowchart and a combination of blocks in the block diagram and/or flowchart may be implemented by using a dedicated hardware-based system that performs a specified function or operation, or may be implemented by using a combination of dedicated hardware and a computer instruction.

Circuits or sub-circuits described in the embodiments of the present disclosure may be implemented by software or hardware. The described circuits or sub-circuits may also be disposed in the processor. For example, it may be described as a processor including a receiving circuit and a processing circuit. The processing circuit includes a writing sub-circuit and a reading sub-circuit. The designations of these circuits or sub-circuits do not constitute a limitation on the circuits or sub-circuits themselves in some cases. For example, the receiving circuit may also be described as “receiving video signals”.

It may be understood that the above embodiments are only exemplary embodiments adopted to illustrate the principles of the present disclosure, but the present disclosure is not limited to these. Those of ordinary skill in the art may make various variations and improvements without departing from the spirit and essence of the present disclosure, and these variations and improvements all fall within the protection scope of the present disclosure.

1. A warning method for environment detection, comprising:
acquiring a video stream of a preset collection region, sequentially collecting frame images from the video stream as detection images, and acquiring an object detection result by inputting the detection images into an image recognition model, wherein the object detection result comprises fugitive dust level information;
determining, in a case that the object detection result comprises a fugitive dust detection box, fugitive dust state information based on positioning information of the fugitive dust detection box;
using the fugitive dust state information and the fugitive dust level information as detection data; and
giving a fugitive dust warning in a case that a fugitive dust warning condition is satisfied based on the detection data and a historical detection data set; and updating, in the case that the fugitive dust warning condition is satisfied based on the detection data and the historical detection data set, the historical detection data set based on the detection data, and returning to perform a step of sequentially collecting frame images from the video stream as detection images.

2. The warning method for environment detection according to claim 1, wherein the fugitive dust state information comprises a first state value representing a presence of fugitive dust and a second state value representing an absence of the fugitive dust; the historical detection data set comprises historical detection data corresponding to at least one frame of historical detection image collected historically; and
said determining the fugitive dust state information based on the positioning information of the fugitive dust detection box comprises:
determining whether the fugitive dust detection box satisfies a first preset condition based on the positioning information of the fugitive dust detection box;
determining that the fugitive dust state information is the first state value in a case that the fugitive dust detection box satisfies the first preset condition; and
determining that the fugitive dust state information is the second state value in a case that the fugitive dust detection box does not satisfy the first preset condition.

3. The warning method for environment detection according to claim 1, wherein the historical detection data set is capable of containing no more than a preset number of historical detection data items; and
said updating the historical detection data set based on the detection data comprises:
removing, in a case that a number of the historical detection data items in the historical detection data set is equal to the preset number, a historical detection data item with earliest storage time from a current historical detection data set, and adding the detection data to the historical detection data set as a new historical detection data item.

4. The warning method for environment detection according to claim 1, further comprising:
using, in a case that the fugitive dust warning condition is not satisfied based on the historical detection data set and the fugitive dust warning condition is satisfied based on the detection data and the historical detection data set, a time on the condition that the detection images are collected as a fugitive dust start time, and generating fugitive dust warning information.

5. The warning method for environment detection according to claim 1, wherein the detection data comprises a fugitive dust level indicated by the fugitive dust level information; and
said giving the fugitive dust warning in the case that the fugitive dust warning condition is satisfied based on the detection data and the historical detection data set comprises:
giving, in response to a preset warning mechanism being a real-time warning mechanism, the fugitive dust warning based on a fugitive dust level in the detection data and fugitive dust levels in the historical detection data set; and
giving, in response to the preset warning mechanism being an interval warning mechanism and a time difference between a current system time and a last warning time after the fugitive dust warning is given being greater than an interval warning duration, the fugitive dust warning based on the fugitive dust level in the detection data and the fugitive dust levels in the historical detection data set.

6. The warning method for environment detection according to claim 2, wherein after giving the fugitive dust warning, the method further comprises:
determining, in response to a sum of the state values in a preset number of historical detection data items being less than or equal to a second preset threshold, that fugitive dust in the preset collection region ends, and recording a fugitive dust end time.

7. The warning method for environment detection according to claim 2, wherein the first preset condition comprises that an area of the fugitive dust detection box is greater than or equal to a third preset threshold; and/or intersection over union of the fugitive dust detection box and a preset fugitive dust reference box is greater than or equal to a fourth preset threshold.

8. The warning method for environment detection according to claim 1, wherein after giving the fugitive dust warning, the method further comprises:
returning to perform the step of sequentially collecting frame images from the video stream as detection images and acquiring the object detection result by inputting the detection images into the image recognition model, and in a case that the object detection result further comprises an exposed soil dreg detection box, determining whether the exposed soil dreg detection box satisfies a second preset condition based on positioning information of the exposed soil dreg detection box; and
giving, in response to each exposed soil dreg detection box satisfying the second preset condition within a first preset frame number range, an exposed soil dreg warning and generating exposed soil dreg warning information, wherein the exposed soil dreg warning information comprises a location of exposed soil dregs within the preset collection region.

9. The warning method for environment detection according to claim 8, wherein the second preset condition comprises that a number of the exposed soil dreg detection boxes is greater than or equal to a fifth preset threshold; and/or an area of the exposed soil dreg detection box is greater than or equal to a sixth preset threshold; and/or intersection over union of the exposed soil dreg detection box and a preset exposed soil dreg reference box is greater than or equal to a seventh preset threshold.

10. The warning method for environment detection according to claim 1, wherein after giving the fugitive dust warning, the method further comprises:
sending, in a case that a fugitive dust level indicated by the fugitive dust warning reaches a preset fugitive dust level, an instruction for persons to evacuate the preset collection region;
returning, in response to receiving an instruction to track the persons, to perform the step of sequentially collecting frame images from the video stream as detection images and acquiring the object detection result by inputting the detection images into the image recognition model, and in a case that the object detection result further comprises a person detection box, determining a number of persons in a preset evacuation reference box based on positioning information of the person detection box and positioning information of the preset evacuation reference box; and
giving, in a case that the number of persons is greater than or equal to an eighth preset threshold and an evacuation duration is greater than or equal to a preset evacuation duration, a person evacuation warning, wherein the evacuation duration is a difference between a current system time and an evacuation start time, the evacuation start time being a time responsive to receiving an instruction to track the persons.

11. The warning method for environment detection according to claim 1, wherein after giving the fugitive dust warning, the method further comprises:
returning to perform the step of sequentially collecting frame images from the video stream as detection images, and acquiring the object detection result by inputting the detection images into the image recognition model, and in a case that the object detection result further comprises a sign detection box, determining a matching result of the sign detection box and a preset sign reference box based on positioning information of the sign detection box and positioning information of the preset sign reference box; and
giving, in a case that the sign detection box does not match the preset sign reference box within a third preset frame number range, a sign warning and generating sign warning information, wherein the sign warning information comprises a location of a sign in the preset collection region.

12. The warning method for environment detection according to claim 1, wherein before inputting the detection images into an image recognition model, the method further comprises:
training the image recognition model,
said training the images recognition model comprises:
acquiring multi-frame sample images of the preset collection region, and labeling the sample images with sample labels, wherein the sample label comprises location information of at least one reference box corresponding to the preset collection region and category information of each reference box, the category information comprising one of a weather category, a person category, a sign category, and an exposed soil dreg category;
training the image recognition model to be trained based on the sample images and the sample labels; and
constructing a weighted loss value and continuously training the image recognition model by performing weighted backpropagation on the weighted loss value until the weighted loss value converges to acquire a trained image recognition model.

13. (canceled)

14. A computer device, comprising a processor, a memory, and a bus, wherein the memory stores machine-readable instructions executable by the processor; when the computer device is running, the processor communicates with the memory via the bus; and the processor, when loading and executing the machine-readable instructions, is caused to perform a warning method for environment detection, wherein the method comprises:
acquiring a video stream of a preset collection region, sequentially collecting frame images from the video stream as detection images, and acquiring an object detection result by inputting the detection images into an image recognition model, wherein the object detection result comprises fugitive dust level information;
determining, in a case that the object detection result comprises a fugitive dust detection box, fugitive dust state information based on positioning information of the fugitive dust detection box;
using the fugitive dust state information and the fugitive dust level information as detection data; and
giving a fugitive dust warning in a case that a fugitive dust warning condition is satisfied based on the detection data and a historical detection data set; and updating, in the case that the fugitive dust warning condition is satisfied based on the detection data and the historical detection data set, the historical detection data set based on the detection data, and returning to perform a step of sequentially collecting frame images from the video stream as detection images.

15. A non-transitory computer-readable storage medium storing at least one computer program thereon, wherein the at least one computer program, when loaded and executed by a processor, causes the processor to perform a warning method for environment detection, wherein the method comprises:
acquiring a video stream of a preset collection region, sequentially collecting frame images from the video stream as detection images, and acquiring an object detection result by inputting the detection images into an image recognition model, wherein the object detection result comprises fugitive dust level information;
determining, in a case that the object detection result comprises a fugitive dust detection box, fugitive dust state information based on positioning information of the fugitive dust detection box;
using the fugitive dust state information and the fugitive dust level information as detection data; and
giving a fugitive dust warning in a case that a fugitive dust warning condition is satisfied based on the detection data and a historical detection data set; and updating, in the case that the fugitive dust warning condition is satisfied based on the detection data and the historical detection data set, the historical detection data set based on the detection data, and returning to perform a step of sequentially collecting frame images from the video stream as detection images.

16. The warning method for environment detection according to claim 2, said the fugitive dust warning condition is satisfied based on the detection data and the historical detection data set comprises:
acquiring a state value sum by accumulatively calculating a sum of state value in the detection data and state values in various historical detection data items in the historical detection data set; and
determining that the fugitive dust warning condition is satisfied in a case that the state value sum is greater than or equal to a first preset threshold.

17. The warning method for environment detection according to claim 2, wherein the historical detection data set is capable of containing no more than a preset number of historical detection data items; and
said updating the historical detection data set based on the detection data comprises:
removing, in a case that a number of the historical detection data items in the historical detection data set is equal to the preset number, a historical detection data item with earliest storage time from a current historical detection data set, and adding the detection data to the historical detection data set as a new historical detection data item.

18. The computer device according to claim 14, wherein the fugitive dust state information comprises a first state value representing a presence of fugitive dust and a second state value representing an absence of the fugitive dust; the historical detection data set comprises historical detection data corresponding to at least one frame of historical detection image collected historically; and
the processor, when loading and executing the machine-readable instructions, is caused to perform:
determining whether the fugitive dust detection box satisfies a first preset condition based on the positioning information of the fugitive dust detection box;
determining that the fugitive dust state information is the first state value in a case that the fugitive dust detection box satisfies the first preset condition; and
determining that the fugitive dust state information is the second state value in a case that the fugitive dust detection box does not satisfy the first preset condition.

19. The computer device according to claim 14, wherein the historical detection data set is capable of containing no more than a preset number of historical detection data items; and
the processor, when loading and executing the machine-readable instructions, is caused to perform:
removing, in a case that a number of the historical detection data items in the historical detection data set is equal to the preset number, a historical detection data item with earliest storage time from a current historical detection data set, and adding the detection data to the historical detection data set as a new historical detection data item.

20. The computer device according to claim 14, the processor, when loading and executing the machine-readable instructions, is caused to perform:
using, in a case that the fugitive dust warning condition is not satisfied based on the historical detection data set and the fugitive dust warning condition is satisfied based on the detection data and the historical detection data set, a time on the condition that the detection images are collected as a fugitive dust start time, and generating fugitive dust warning information.

21. The computer device according to claim 14, wherein the detection data comprises a fugitive dust level indicated by the fugitive dust level information; and
the processor, when loading and executing the machine-readable instructions, is caused to perform:
giving, in response to a preset warning mechanism being a real-time warning mechanism, the fugitive dust warning based on a fugitive dust level in the detection data and fugitive dust levels in the historical detection data set; and
giving, in response to the preset warning mechanism being an interval warning mechanism and a time difference between a current system time and a last warning time after the fugitive dust warning is given being greater than an interval warning duration, the fugitive dust warning based on the fugitive dust level in the detection data and the fugitive dust levels in the historical detection data set.
